(19) United States
(12) Patent Application Publication
(10) Pub. No.: US 2006/0140410 A1
(43) Pub. Date: Jun. 29, 2006

(54) Wireless communication device and wireless communication method

(75) Inventor: Tadahiro Aihara, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/315,205

(22) Filed: Dec. 23, 2005

(30) Foreign Application Priority Data
Dec. 27, 2004 (JP) P2004-375445

(51) Int. Cl. H04K 1/00

(52) U.S. Cl. 380/273

(57) ABSTRACT

A wireless communication device for wirelessly transmitting data from a plurality of data sources to a different device. The wireless communication device includes: an authentication unit that authenticates the different device; an encryption unit that encrypts the data from the data source using a cipher key; a communication unit that transmits the data encrypted by the encryption unit to the different device authenticated by the authentication unit; a switch unit that switches the data source for supplying the data transmitted to the different device; and a cipher key update unit that updates the cipher key used by the encryption unit when the switch unit switches the data source.

The entire disclosure of Japanese Patent Application No. 2004-375445 filed on Dec. 27, 2004 including specification, claims, drawings and abstract is incorporated herein by reference in its entirety.

### BACKGROUND

1. Field

One embodiment of the invention relates to a wireless communication device such as an access point apparatus used with a wireless LAN system, for example, and a wireless communication method.

2. Description of the Related Art

In recent years, a wireless LAN system wherein terminals communicate wireless communications through an access point apparatus has sprung into wide use. Such a wireless system does not require wiring and has high expandability as compared with a wired system; on the other hand, providing security becomes an important problem because the wireless system is a system wherein data can be received anywhere in the range in which radio waves reach and it is difficult to limit the destination. The IEEE802.11 standard adopts a cipher key system based on WEP (Wired Equivalent Privacy) to prevent a third party from intercepting communication data. Recently, an encryption scheme such as TKIP (Temporal Key Integrity Protocol), WRAP (Wireless Robust Authenticated Protocol), or CCMP (Counter mode with CBC-MAC Protocol) has also been adopted in WPA (Wi-Fi Protected Access) or IEEE802.11i.

To further enhance safety, a system for updating a cipher key for each communication is designed. (For example, refer to JP-A-11-234260) JP-A-11-234260 proposes a technique of generating a cipher key in an access point apparatus for each communication and transmitting the cipher key to a station terminal, thereby using a different cipher key every time. The mechanism capable of thus updating the cipher key as desired is also defined in WPA, IEEE802.11i, etc., mentioned above.

On the other hand, the wireless LAN has comparatively high throughput of 11 Mbps in IEEE802.11b or 54 Mbps in IEEE802.11a, IEEE802.11g and thus can be used not only as general data communication means, but also as means for transmitting highly real-time data such as video data of a TV, video, etc.

However, in the technique described in patent document 1, the cipher key cannot be updated unless the user disconnects connection. Thus, for example, if the user continues to use the system in an always-on connection mode, etc., meanwhile the cipher key is not updated.

To improve safety of data, it is also considered that the cipher key is forcibly updated every given time or each time a given number of packets or more packets are communicated. However, in such a technique, a new cipher key is generated and connection is made based on the cipher key and therefore it becomes necessary to once disconnect connection. This means that meanwhile the user cannot transmit or receive data. This problem becomes noticeable particularly when highly real-time data is transmitted as described above, for example, when the user views video data of a TV, etc., through the wireless LAN.

### SUMMARY

The invention provides a wireless communication device for updating a cipher key at a more appropriate timing.

The invention may provide a wireless communication device for wirelessly transmitting data from a plurality of data sources to a different device, the wireless communication device including: an authentication unit that authenticates the different device; an encryption unit that encrypts the data from the data source using a cipher key; a communication unit that transmits the data encrypted by the encryption unit to the different device authenticated by the authentication unit; a switch unit that switches the data source for supplying the data transmitted to the different device; and a cipher key update unit that updates the cipher key used by the encryption unit when the switch unit switches the data source.

The invention may provide a wireless communication device for wirelessly transmitting data, the wireless communication device including: an authentication unit that authenticates the different device; an encryption unit that encrypts the data using a cipher key; a communication unit that transmits the data encrypted by the encryption unit to the different device authenticated by the authentication unit; a detection unit that detects a signal indicating a change in supplying the data to the different device; and a cipher key update unit that updates the cipher key used by the encryption unit when the detection unit detects the change of the supply of the data.

The invention may provide a wireless communication method of transmitting data from a plurality of data sources to a different device in a wireless manner, the wireless communication method including: authenticating the different device; encrypting the data from the data source using a cipher key; transmitting the data to the different device; switching the data source for supplying the data transmitted to the different device; and updating the cipher key used for encrypting the data when the data source is switched.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a drawing to show the exemplary configuration of a communication system including an access point apparatus according to a first embodiment of the invention;

FIG. 2 is a block diagram to show the exemplary configuration of the access point apparatus according to the first embodiment of the invention; and

FIG. 3 is a flowchart to show an exemplary processing flow of a program for controlling the access point apparatus according to the first embodiment of the invention, involved in connection to and communication with a notebook PC.

FIG. 4 is a block diagram to show the exemplary configuration of the access point apparatus according to the second embodiment of the invention; and

FIG. 5 is a flowchart to show an exemplary processing flow of a program for controlling the access point apparatus according to the second embodiment of the invention, involved in connection to and communication with a notebook PC.

### DETAILED DESCRIPTION

A wireless communication device, a program for controlling the wireless communication device, and a wireless communication method of the invention will be discussed with reference to the accompanying drawings.

### First Embodiment

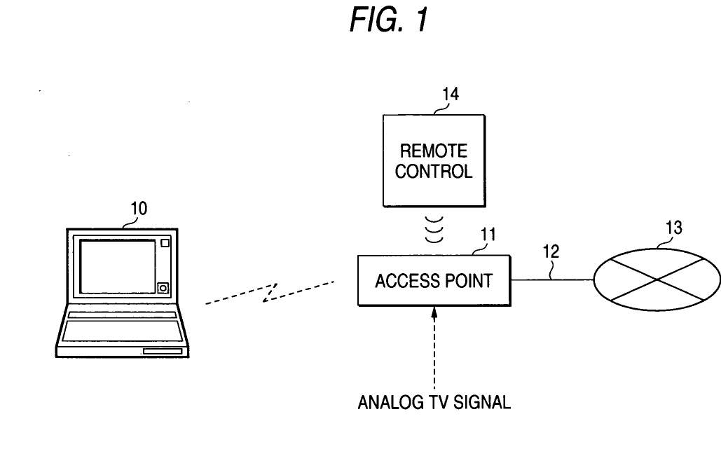

FIG. 1 is a drawing to show the configuration of a communication system including an access point apparatus of an embodiment of the wireless communication device of the invention. This communication system is made up of a notebook PC (Personal Computer) 10, an access point apparatus 11 for communicating with the notebook PC 10 through a wireless LAN, and a network 13 connected to the access point apparatus 11 via a wired LAN cable 12. In the communication system, wireless communications between the notebook PC 10 and the access point apparatus 11 are communicated in conformity with IEEE802.11, IEEE802.11a, IEEE802.11i standard.

The notebook PC 10 communicates with the access point apparatus 11 through the wireless LAN. The notebook PC 10 can connect to the network 13 through the access point apparatus 11 and can receive video data sent from the access point apparatus 11 for enabling the user to view the video data. When transferring data to and from the access point apparatus 11, the notebook PC 10 has a function of encrypting and decrypting the data.

The access point apparatus 11, which is a relay for relaying between the notebook PC 10 and the network 13, forms a wireless service area for the wireless LAN for the notebook PC 10 and is also accommodated in the network 13 by the wired LAN cable 12. When the access point apparatus 11 transmits and receives data to and from the notebook PC 10, the access point apparatus 11 has a function of encrypting and decrypting the data.

An analog TV signal can be input to the access point apparatus 11. The notebook PC 10 can receive the video data of the analog TV signal by wireless LAN communications for enabling the user to view the video data. The user switches the channel of the analog TV signal input to the access point apparatus 11 with a remote control 14.

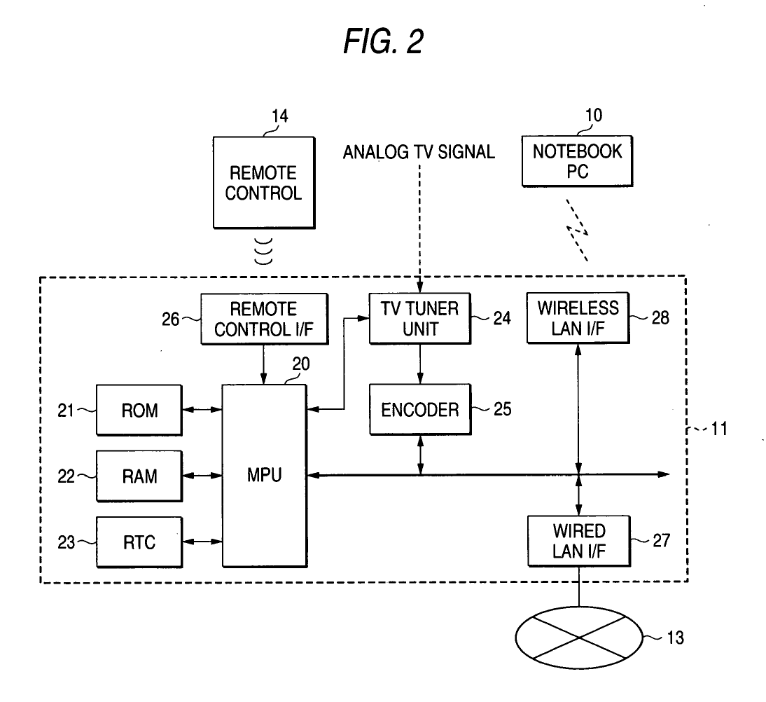

FIG. 2 is a block diagram to show the configuration of the access point apparatus 11. The access point apparatus 11 is made up of an MPU (Micro processing Unit) 20, ROM (Read-Only Memory) 21, RAM (Random Access Memory) 22, an RTC (Real Time Clock) 23 for generating time information, a TV tuner unit 24 for inputting an analog TV signal, an encoder 25 for converting an analog TV signal into a digital signal and encoding the signal, a remote control interface 26, a wired LAN interface 27, and a wireless LAN interface 28.

The MPU 20 is a processor provided for controlling the whole operation of the access point apparatus 11 and executes various programs having a function of authenticating the notebook PC 10 through the wireless LAN interface 28, a function of encrypting/decrypting the data transmitted to and received from the notebook PC 10, a control function of decoding an operation signal input from the remote control interface 26 and switching the channel of the TV tuner unit 24, a function of controlling transmission of video data created by the encoder 25 to the notebook PC 10 through the wireless LAN interface 28 in accordance with a request of the notebook PC 10, and the like.

The ROM 21 is nonvolatile memory storing the above-mentioned programs, and the RAM 22 is used as work memory for the MPU 20 to execute the programs. The RTC 23 is an IC (Integrated Circuit) dedicated to clocking and generates time information. The MPU 20 records the start time of communications with the notebook PC 10 in the RAM 22 and can make a comparison between the communication start time and the time information generated by the RTC 23, thereby calculating the elapsed time since connection with the notebook PC 10 was started.

The TV tuner unit 24 switches the channel of an external input analog TV signal and selects only one channel under the control of the MPU 20 as the user operates the remote control 14.

The encoder 25 is an encoder IC for encoding processing of converting an analog TV signal input through the TV tuner unit 24 into a digital signal and compressing data. The created video data is data encoded to MPEG2 (Moving Picture Experts Group phase 2), for example.

The remote control interface 26 is an interface for receiving an infrared remote control signal based on operation of the remote control 14 by the user and transmitting the signal to the MPU 20. If the user operates the remote control 14 to switch the channel, the remote control interface 26 receives the remote control signal and transmits the signal to the MPU 20, which then switches the channel of the TV tuner unit 24 based on the received signal.

The wired LAN interface 27 is an interface for connecting the access point apparatus 11 to the network 13 through the wired LAN cable 12.

The wireless LAN interface 28 is an interface for communicating with the notebook PC 10 through the wireless LAN. The wireless LAN interface 28 transmits data from the network 13 connected through the wired LAN interface 27 to the notebook PC 10 and transmits vided data provided by the encoder 25 to the notebook PC 10 under the control of the MPU 20.

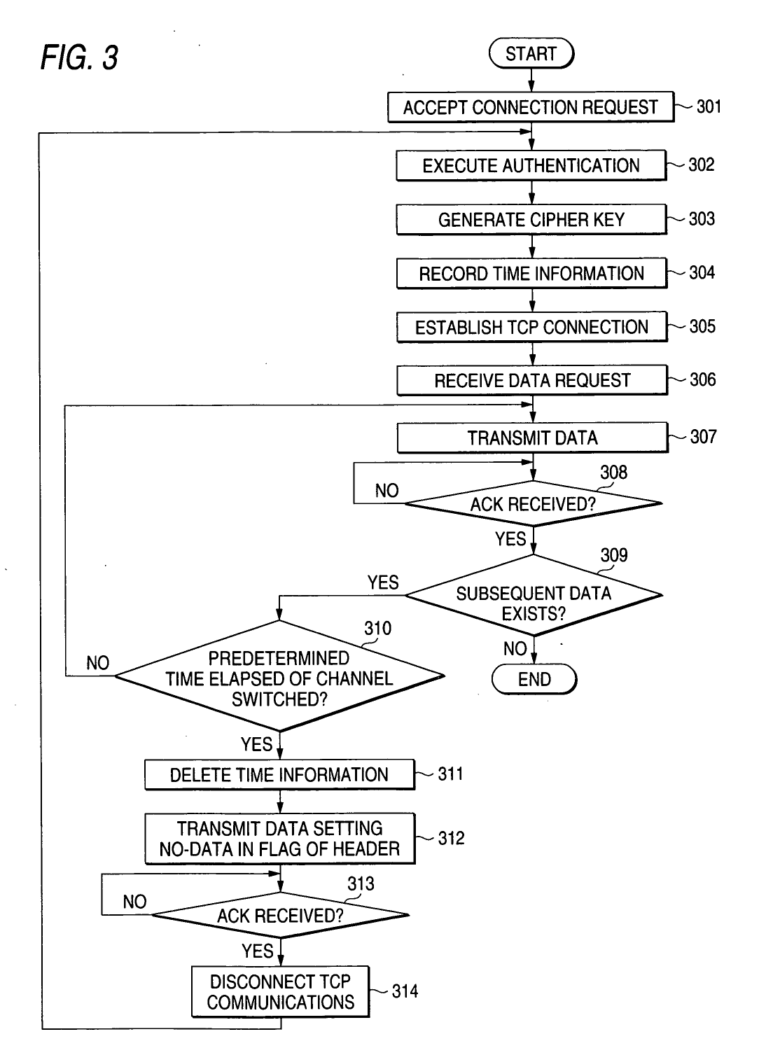

Subsequently, a processing flow of the access point apparatus 11 involved in connection to and communication with the notebook PC 10 will be discussed. FIG. 3 is a flowchart to show a processing flow of a program for controlling the access point apparatus 11, involved in connection to and communication with the notebook PC 10. In the description made with reference to the figure, it is assumed that TCP/IP (Transmission Control Protocol/Internet Protocol) and HTTP (Hyper Text Transfer Protocol) are used for transmitting and receiving data. It is assumed that an interconnectable value is preset as the IP address.

To begin with, the access point apparatus 11 accepts a connection request from the notebook PC 10 at the wireless LAN interface 28 (step 301). The connection processing is wireless connection defined in IEEE802.11 and a connection request in made in the flow of join, authentication, and association. The “join” is processing for synchronization between the notebook PC 10 and the access point apparatus 11 and the “authentication” is open system authentication. Logical connection is complete in association.

After logical connection is established at step 301, authentication is completed (step 302) and a cipher key is generated (step 303). The authentication and the generation of the cipher key are authentication encryption scheme defined in IEEE802.11i and have EAP-TLS authentication based on an electronic certificate and session cipher key generation and cipher key distribution steps called 4-way handshake and group key handshake. In 4-way handshake, key information used for one-to-one communications with the notebook PC 10 is generated and in group key handshake, a cipher key used in broadcast communications is generated by the MPU 20 of the access point apparatus 11 and is distributed to the notebook PC 10.

After the cipher key is generated, the RTC 23 is referenced and the communication start time with the notebook PC 10, namely, the use start time of the cipher key created at step 303 is recorded in the RAM 22 (step 304). A comparison is made between the start time and the RTC 23, whereby it is made possible to know the use time of the cipher key.

Next, TCP connection is established between the wireless LAN interface 28 and the notebook PC 10 based on the cipher key created at step 303 (step 305). As TCP connection is established, it is made possible to transfer data between the access point apparatus 11 and the notebook PC 10.

After TCP connection is established, if a GET command of a data request command defined in HTTP is received at the wireless LAN interface 28 from the notebook PC 10 (step 306), data transmission is started from the wireless LAN interface 28 (step 307). Here, it is assumed that the data sent from the wireless LAN interface 28 is data provided by encrypting the video data provided by encoding an analog TV signal by the encoder 25 using the cipher key created at step 303.

If the data is transmitted, then whether or not ACK indicating the data has been received is received at the wireless LAN interface 28 from the notebook PC 10 (step 308). If ACK is not returned (NO at step 308), the access point apparatus 11 waits for receiving ACK. If ACK is returned (YES at step 308), whether or not subsequent data to be sent to the notebook PC 10 exists is determined (step 309). If subsequent data does not exist (NO at step 309), the processing is terminated.

If the data to be sent to the notebook PC 10 still exists (YES at step 309), whether or not the cipher key created at step 303 is used for a predetermined time or more or whether or not user switches the channel is determined (step 310). The elapsed time can be calculated by making a comparison between the communication start time recorded in the RAM 22 at step 304 (namely, the use start time of the cipher key) and the time of the RTC 23. Whether or not the channel is switched is determined by whether or not a remote control signal involved in channel switching is received at the remote control interface 26. If a remote control signal involved in channel switching is received at the remote control interface 26, the channel of the TV tuner unit 24 is switched in response to the received remote control signal.

If it is determined at step 310 that the predetermined time has not yet elapsed and that the channel is not switched (NO at step 310), it is determined that the cipher key need not be updated, and subsequent data is transmitted (step-307). If it is determined that the predetermined time has elapsed or that the channel is switched (YES at step 310), processing for updating the cipher key is entered. First, the communication start time recorded in the RAM 22 (namely, the use start time of the cipher key created at step 303) is deleted (step 311).

Subsequently, data setting a flag (no-data) indicating that no more data exists in a header is transmitted from the wireless LAN interface 28 to the notebook PC 10 (step 312). After this, whether or not ACK indicating that the data has been received is returned from the notebook PC 10 to the wireless LAN interface 28 (step 313). If ACK is not returned (NO at step 313), the access point apparatus 11 waits for receiving ACK. If ACK is returned from the notebook PC 10 (YES at step 313), the TCP connection with the notebook PC 10 is disconnected (step 314) and authentication is completed (step 302) and then a new cipher key is generated (step 303) and TCP communications based on the new cipher key are begun with the notebook PC 10.

As described above, according to the embodiment, the cipher key is updated based on the fact that a remote control signal involved in channel switching is received at the remote control interface 26. Since video data does not have continuity at the channel switching time, the TCP connection is disconnected (step 314) and the cipher key is updated at the same timing as the channel switching, whereby interference with data transmission/reception to/from the user can be suppressed.

The cipher key is updated not only when the channel is switched, but also when the elapsed time since the use start of the cipher key exceeds one predetermined time. Thus, if the user continues to view video data of the same channel, the cipher key is updated at regular time intervals and safety can be improved.

In place of the time, the number of packets of data sent from the wireless LAN interface 28 to the notebook PC 10 may be measured by the program executed in the MPU 20. Also in this case, similar advantages can be provided if the cipher key is forcibly updated when the measured number of packets exceeds a given number of packets.

In the embodiment, whenever the cipher key is updated, authentication is completed and another cipher key is generated, so that higher safety can be provided as compared with a technique of selecting one key from among several predetermined keys for communications.

In the embodiment, only analog TV signals are accepted, but a video signal and a TV signal may be switched, etc., for example, or it is also considered that the input video signal is digital, in which case the encoder 25 is not necessarily required.

The data need not necessarily be video data; for example, it is also considered that the data is voice data of a radio, etc.

In the embodiment, a remote control signal is transmitted from the remote control 14 to the remote control interface 26, whereby the channel of the analog TV signal of the TV tuner unit 24 is switched; in addition, channel switching may be able to be controlled through the wireless LAN interface 28 from the notebook PC 10 by wireless LAN communications.

### Second Embodiment

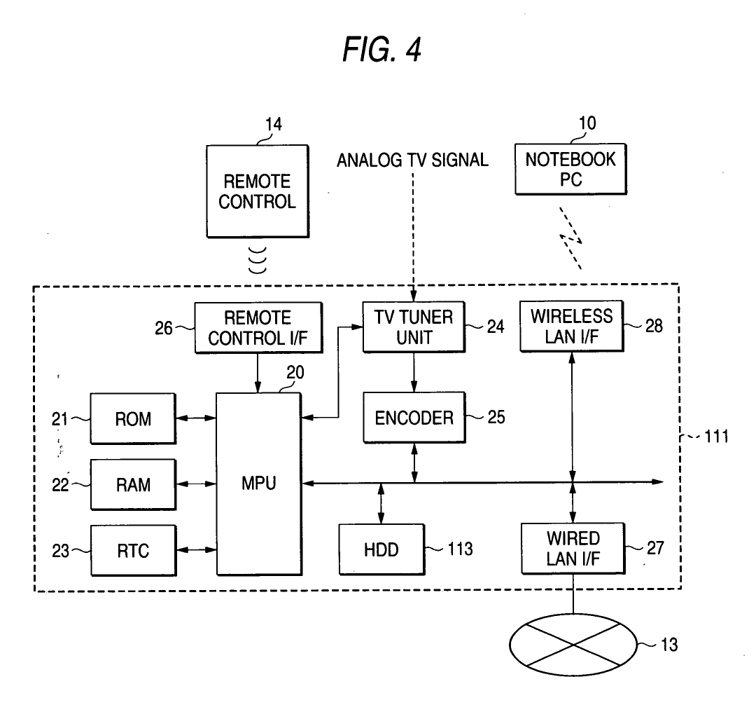

FIG. 4 is a block diagram showing another configuration of a communication system including an access point apparatus functioning as the wireless communication device of the invention. The communication system shown in FIG. 4 is broadly the same as the configurations shown in FIG. 2. In this communication system, however, the access point apparatus 111 has a HDD 113 that stores data including a plurality of contents, such as motion pictures, still pictures and music. These contents can be read from the HDD 113 and transmitted to the notebook PC 10 according to a remote control signal from the remote controller 14 which is received at the remote control interface 26. The contents may be read from HDD 113 according to a requirement of user entered at the notebook PC 10 and transmitted to the wireless LAN interface 28.

In the access point apparatus 111, ROM 21 stores a program for detecting an output signal from the remote control interface 26 and the wireless LAN interface 28 when such output signal indicates a change in supplying the data to be transmitted from the wireless LAN interface 28 to the notebook PC 10. This program is extended and executed in the MPU 20 and functions as a detecting unit of the invention: When the remote control interface 26 receives a remote control signal from the remote controller 14 which requires switching of the contents currently being read from the HDD 113 to other contents that is stored in the HDD 113, MPU 20 detects the reception of such signal.

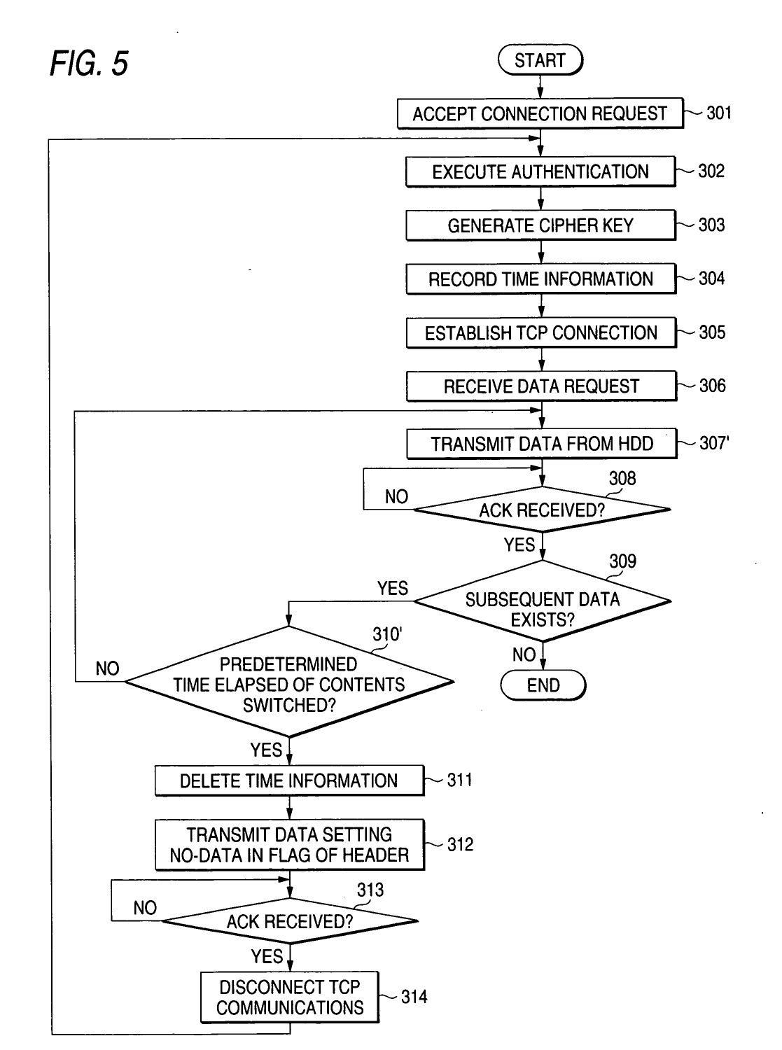

FIG. 5 is a flowchart showing the processing in the access point apparatus 111. This flowchart is generally the same as the flowchart shown in FIG. 3. In FIG. 5, it is assumed that the data sent from the wireless LAN interface 28 is data provided by encrypting the data read from the HDD 113. (Step 307′). In Step 310′, it is determined whether or not the cipher key created at step 303 is used for a predetermined time or more, or whether or not the user switches the contents. This determination as to the switching of the contents is done when the MPU 20 detects that the remote control interface 26 receives the remote control signal involving a command for switching the contents. This determination may be also done when the MPU 20 detects that the wireless LAN interface 28 receives a command for switching the contents from the notebook PC 10.

By having the configuration as above, updating a cipher key can be done at a more appropriate timing, without disturbing the user viewing the contents.

In this embodiment, another configuration may be adopted without departing from the scope and spirit of the invention. In the step 310′, the MPU 20 (functioning as the detection unit) may detect any signal that indicates a changing in supplying data to the notebook PC 10. For example, the MPU 20 may detect a signal indicating switching of the input lines used for external input of signals involving pictures and sounds. Further, the MPU 20 may detect operation signals for playing back the contents, such as stop, pause, fast-forward, fast-rewind of the contents.

Further, the MPU 20 may detect a signal indicating timing for a change of sound from monaural sound to stereophonic sound. The MPU 20 may detect a signal indicating a change of pictures such as a change of programs in a digital broadcasting.

What is claimed is:

1. A wireless communication device for wirelessly transmitting data from a plurality of data sources to a different device, the wireless communication device comprising:
an authentication unit that authenticates the different device;
an encryption unit that encrypts the data from the data source using a cipher key;
a communication unit that transmits the data encrypted by the encryption unit to the different device authenticated by the authentication unit;
a switch unit that switches the data source for supplying the data transmitted to the different device; and
a cipher key update unit that updates the cipher key used by the encryption unit when the switch unit switches the data source.

2. The wireless communication device as claimed in claim 1, further comprising:
a clock unit that calculates the elapsed time of communications based on the cipher key used by the encryption unit;
wherein when the elapsed time of communications based on the cipher key, calculated by the clock unit exceeds a predetermined time, the cipher key update unit updates the cipher key used by the encryption unit.

3. The wireless communication device as claimed in claim 1 further comprising:
a data amount measurement unit that measures the data amount of data sent by the communication unit after the start of communications based on the cipher key used by the encryption unit;
wherein when the data amount of data sent by the communication unit after the start of communications based on the cipher key, measured by the data amount measurement unit exceeds a predetermined amount, the cipher key update unit updates the cipher key used by the encryption unit.

4. The wireless communication device as claimed in claim 1,
wherein when the switch unit switches the data source, the cipher key update unit generates a new cipher key used by the encryption unit.

5. A wireless communication device for wirelessly transmitting data, the wireless communication device comprising:
an authentication unit that authenticates the different device;
an encryption unit that encrypts the data using a cipher key;
a communication unit that transmits the data encrypted by the encryption unit to the different device authenticated by the authentication unit;
a detection unit that detects a signal indicating a change in supplying the data to the different device; and
a cipher key update unit that updates the cipher key used by the encryption unit when the detection unit detects the change of the supply of the data.

6. The wireless communication device as claimed in claim 5,
wherein the data includes a plurality of contents;
the detection unit detects a switch signal for switching one of the plurality of contents to another one of the plurality of contents; and
the cipher key update unit updates the cipher key used when the detection unit detects the switch signal.

7. The wireless communication device as claimed in claim 5,
wherein the detection unit detects a signal for operating reproduction the data; and
the cipher key update unit updates the cipher key used when the detection unit detect the signal for operating the data.

8. The wireless communication device as claimed in claim 5, further comprising:
a clock unit that calculates the elapsed time of communications based on the cipher key used by the encryption unit;
wherein when the elapsed time of communications based on the cipher key, calculated by the clock unit exceeds a predetermined time, the cipher key update unit updates the cipher key used by the encryption unit.

9. The wireless communication device as claimed in claim 5, further comprising:
a data amount measurement unit that measures the data amount of data sent by the communication unit after the start of communications based on the cipher key used by the encryption unit;
wherein when the data amount of data sent by the communication unit after the start of communications based on the cipher key, measured by the data amount measurement unit exceeds a predetermined amount, the cipher key update unit updates the cipher key used by the encryption unit.

10. The wireless communication device as claimed in claim 5,
wherein when the detection unit detects the signal, the cipher key update unit generates a new cipher key used by the encryption unit.

11. A wireless communication method of transmitting data from a plurality of data sources to a different device in a wireless manner, the wireless communication method comprising:
authenticating the different device;
encrypting the data from the data source using a cipher key;
transmitting the data to the different device;
switching the data source for supplying the data transmitted to the different device; and
updating the cipher key used for encrypting the data when the data source is switched.

12. The wireless communication method claimed in claim 11,
wherein when the switch step switches the data source, the cipher key update step generates a new cipher key used for encryption in said communication step.

13. The wireless communication method claimed in claim 11, further comprising:
calculating the elapsed time of communications based on the cipher key; and
updating the cipher key used for encryption when the elapsed time of communications based on the cipher key exceeds a predetermined time.

14. The wireless communication method claimed in claim 11, further comprising:
measuring the data amount of data transmitted to the different device after start of communications based on the cipher key; and
updating the cipher key used for encryption when the data amount of data transmitted to the different device after start of communications based on the cipher key.
